(19) United States
(12) Patent Application Publication
(10) Pub. No.: US 2016/0348669 A1
(43) Pub. Date: Dec. 1, 2016

(54) METHOD AND SYSTEM FOR FLOW RATE CONTROL OF HYDRAULIC PUMP

(71) Applicant: CATERPILLAR INC., Peoria, IL (US)

(72) Inventors: CORY A. BROWN, PEORIA, IL (US); SANA MAHMOOD, PEORIA, IL (US); LIFENG WANG, DUNLAP, IL (US)

(73) Assignee: CATERPILLAR INC., Peoria, IL (US)

(21) Appl. No.: 14/727,633

(22) Filed: Jun. 1, 2015

(51) Int. Cl. F04B 49/22; F04B 53/10; F16K 27/02; F16K 1/36; F16K 1/52

(52) U.S. Cl. CPC F04B 49/22; F16K 1/36; F16K 1/52; F16K 27/02; F04B 53/1087

(57) ABSTRACT

The disclosure describes a valve assembly including a valve chamber having a first end and a second end opposite the first end. A valve inlet and a valve outlet are in fluid communication with the valve chamber. A valve body is movably disposed within the valve chamber and includes a main fluid passage providing fluid communication between the valve inlet and the valve outlet, and one or more control orifices providing fluid communication between the main fluid passage and at least a portion of the valve chamber. A valve head of the valve body is configured to abut against at least a portion of a valve seat to control a flow of fluid from the one or more control orifices to the valve outlet, while allowing fluid to flow through the main fluid passage.

### TECHNICAL FIELD

This patent disclosure relates generally to a hydraulic pump and, more particularly, to a system and method for controlling a supply flow rate for the hydraulic pump.

### BACKGROUND

Certain gaseous fueled powered engines require a cryogenic pump, such as a hydraulically driven cryogenic pump, to transfer liquefied natural gas from an off-engine system to an on-engine fuel system. However, these cryogenic pumps may be sensitive to hydraulic supply pressure, where an extend velocity of a pump element of the cryogenic pump may exceed desirable velocity thresholds due to supply pressure impulses. Mechanisms for regulating such pressure changes are needed.

As an example, U.S. Pat. No. 5,024,200 purports to provide a pressure regulator having a pressure regulating plunger. In response to pressurized oil contacting a face of the pressure regulating plunger, it moves to the right against the force of a biasing spring. In response to low pressure contacting the face of pressure regulating plunger, biasing spring causes the plunger to move to a return position. However, the regulator of U.S. Pat. No. 5,024,200 is configured to regulated fluid pressure by the diversion of some of the flow output from a pump into a bypass loop including the pressure regulating plunger.

As a further example, U.S. Pat. No. 8,622,046 describes a valve element having a restricted orifice passing through a center thereof to fluidly communicate an inner passage with an outlet of an accumulator. As such, when the valve element is biased by a spring element into the closed position, fuel may only pass through restricted orifice. When the valve element is pushed by fuel pressure to open, fuel may pass both through restricted orifice and between cylindrical sidewalls of the valve element. Accordingly, certain fluid pressures may be regulated in the accumulator using the restricted orifice. However, improvements in the regulation of pressures in a hydraulic pump are still needed.

### SUMMARY

In one aspect, the disclosure describes a valve assembly comprising: a housing defining a valve chamber, wherein the valve chamber comprises a first end and a second end opposite the first end; a valve inlet disposed adjacent the first end of the valve chamber and in fluid communication therewith, wherein the valve chamber is configured to receive a flow of fluid from the valve inlet; a valve outlet in fluid communication with the valve chamber to receive a flow of fluid from the valve chamber; a valve seat fixedly disposed at the first end of the valve chamber; a valve body movably disposed within the valve chamber, the valve body comprising a valve head, a main fluid passage providing fluid communication between the valve inlet and the valve outlet, and one or more control orifices providing fluid communication between the main fluid passage and at least a portion of the valve chamber; and a spring member disposed between the housing and the valve body, wherein the spring member is configured to bias the valve body away from the valve seat and towards the first end of the valve chamber, and wherein the valve head of the valve body is configured to abut against at least a portion of the valve seat to control a flow of fluid from the one or more control orifices to the valve outlet.

In another aspect, the disclosure describes a valve assembly comprising: a housing defining a valve chamber and a main fluid passage, wherein the valve chamber comprises a first end and a second end opposite the first end; a valve inlet disposed adjacent the first end of the valve chamber and in fluid communication therewith, wherein the valve chamber is configured to receive a flow of fluid from the valve inlet; a valve outlet in fluid communication with the valve chamber to receive a flow of fluid from the valve chamber, wherein the main fluid passage provides fluid communication between the valve inlet and the valve outlet; a valve seat fixedly disposed at the first end of the valve chamber; a valve body movably disposed within the valve chamber, the valve body comprising a valve head, a fluid chamber, and one or more control orifices providing fluid communication between the fluid chamber and at least a portion of the valve chamber; and a spring member disposed between the housing and the valve body, wherein the spring member is configured to bias the valve body away from the valve seat and towards the first end of the valve chamber, and wherein the valve head of the valve body is configured to abut against at least a portion of the valve seat to restrict a flow of fluid from the one or more control orifices to the valve outlet

In yet another aspect, the disclosure describes a valve assembly comprising: a housing defining a valve chamber, wherein the valve chamber comprises a first end and a second end opposite the first end; a valve inlet disposed adjacent the first end of the valve chamber and in fluid communication therewith, wherein the valve chamber is configured to receive a flow of fluid from the valve inlet; a valve outlet in fluid communication with the valve chamber to receive a flow of fluid from the valve chamber; a valve seat fixedly disposed at the first end of the valve chamber; a valve body movably disposed within the valve chamber, the valve body comprising a valve head, a main fluid passage providing fluid communication between the valve inlet and the valve outlet, and one or more channels formed on an outer periphery of the valve body to provide fluid communication between the valve inlet and at least a portion of the valve chamber; and a spring member disposed between the housing and the valve body, wherein the spring member is configured to bias the valve body away from the valve seat and towards the first end of the valve chamber, and wherein the valve head of the valve body is configured to abut against at least a portion of the valve seat to control a flow of fluid from the one or more control orifices to the valve outlet.

### BRIEF DESCRIPTION OF THE DRAWINGS

FIG. 1 is a perspective view of a machine constructed in accordance with the aspects of the disclosure.

FIG. 2 is a schematic representation of a liquid natural gas (LNG) and diesel delivery system that may include the systems and methods in accordance with aspects of the present disclosure.

FIG. 3 is a cross-sectional view of a portion of a cryogenic pump including a valve assembly in accordance with aspects of the present disclosure, where the valve assembly is shown in an opened position.

FIG. 4 is a cross-sectional view of the valve assembly of FIG. 3, showing the valve assembly in an opened position.

FIG. 5 is a cross-sectional view of the valve assembly of FIG. 3, showing the valve assembly in an opened position.

FIG. 6 is a cross-sectional view of the valve assembly of FIG. 3, showing the valve assembly in an opened position.

FIG. 7 is a cross-sectional view of a valve assembly in accordance with aspects of the present disclosure, where the valve assembly is shown in an opened position.

FIG. 8 is a perspective view of a valve body in accordance with aspects of the present disclosure.

### DETAILED DESCRIPTION

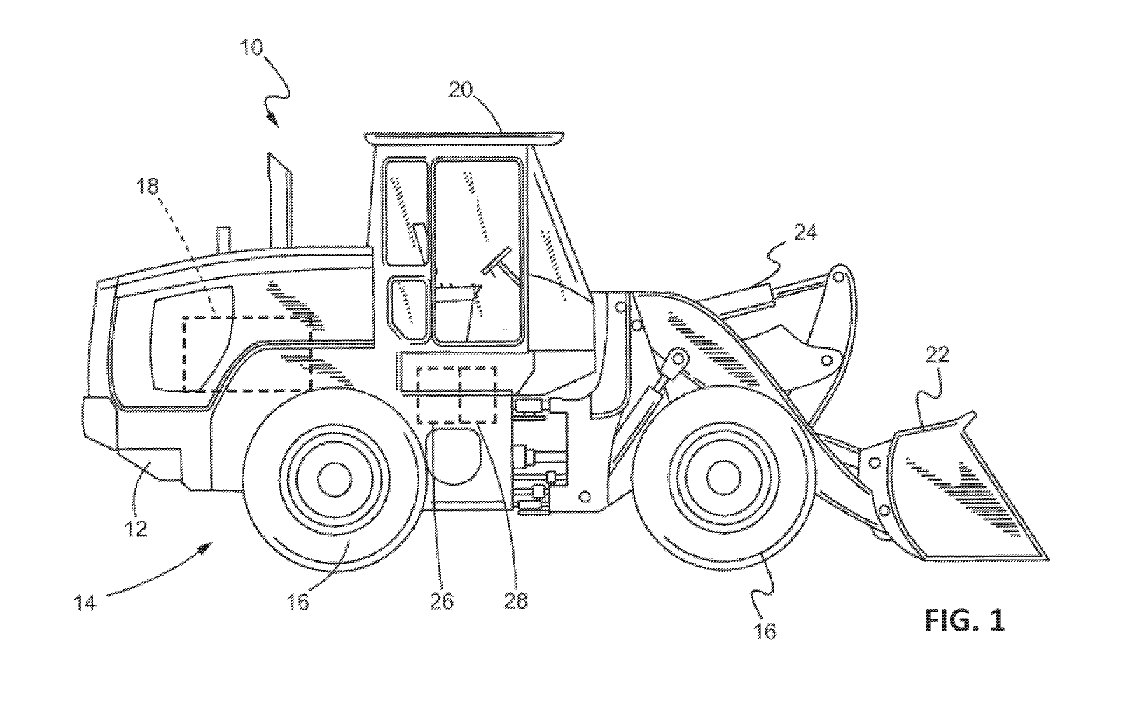

Referring now to the drawings, and with specific reference to FIG. 1, a machine 10 constructed in accordance with the teachings of the disclosure is shown in detail. Although the machine 10 depicted in FIG. 1 is that of a wheeled loader, it is to be understood that the teachings of the disclosure can find equal applicability in connection with many other machines such as, but not limited to, locomotives, track-type tractors, excavators, motor graders, pipe layers, dump trucks, articulated trucks, off-highway vehicles, on highway vehicles, machines in general including marine applications, generator sets, and the like.

As shown therein, the machine 10 may include a chassis 12 supported by a locomotion device 14. While the locomotion device 14 depicted in FIG. 1 is that of a plurality of wheels 16, any number of different other locomotion devices 14 can be used such as, but not limited to, continuous tracks. The chassis 12 may support an engine 18 as well as an operator cabin 20. The engine 18 can be provided in any number of different forms including internal combustion engines such as diesel engines and Otto cycle engines. In addition, the engine 18 may be adapted to run on diesel fuel or other fuels such as, but not limited to, liquefied natural gas (LNG). As used herein, LNG generally refers to liquefied natural gas such as, but not limited to, methane, but other types of natural gas are certainly possible as well.

Extending from the chassis 12, the machine 10 may include one or more work implements 22 adapted for movement relative to the chassis 12 by a plurality of hydraulic cylinders 24. While the work implement 22 is depicted as a bucket in FIG. 1, it is to be understood that any other number of other work implements including, but not limited to, tines, augers, brushes, forks, shovels and the like are certainly possible. As indicated above, the engine 18 may be adapted to operate in part using liquid natural gas as its fuel. Accordingly, a source of liquid natural gas such as a LNG tank 26 may be provided onboard the machine 10. A separate diesel fuel tank 28 may also be provided.

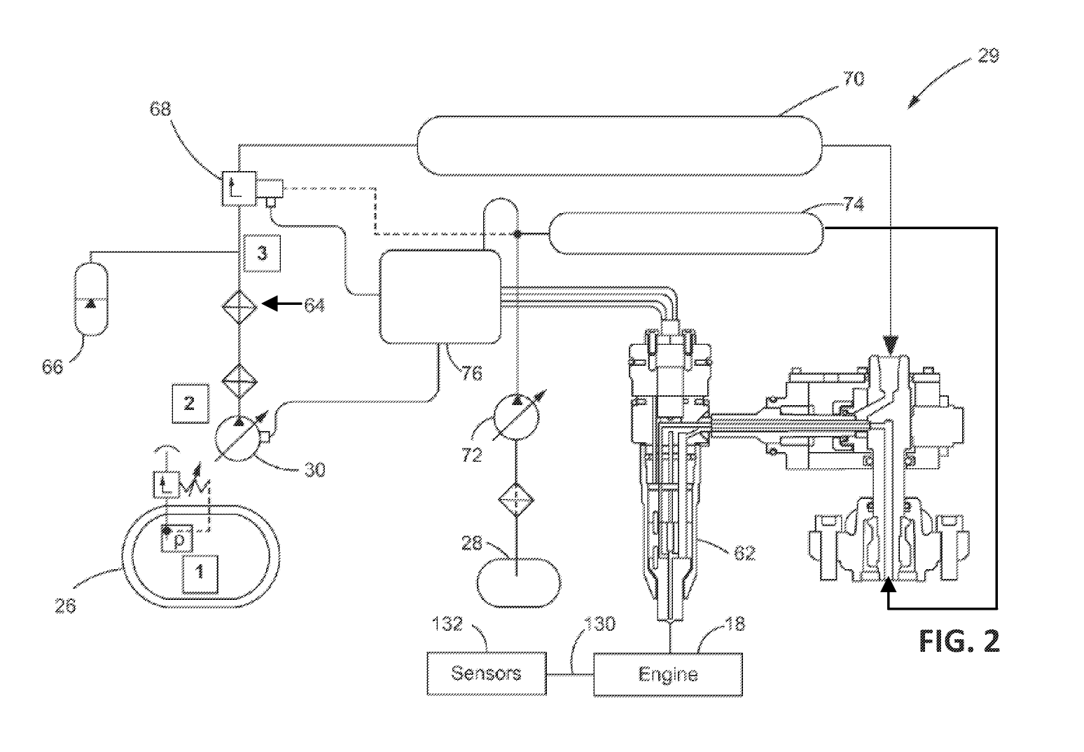

Referring now to FIG. 2, an overall fuel delivery system 29 for the machine 10 is depicted. As shown therein, a LNG cryogenic piston pump 30 may be in fluid communication with the LNG tank 26 for delivery of LNG to a fuel injector 62. The LNG tank 26 may be a cryogenic tank adapted to store the LNG at temperatures as low as −160° C., for example. The system 29 may further include a heat exchanger 64 to convert the LNG from LNG to CNG (compressed natural gas), and an accumulator 66 to store the added volume generated after the conversion and serve as a reservoir to ensure adequate pressure is always available. A pressure control valve 68 may be disposed downstream of the heat exchanger 64 prior to provision of the gas to a CNG rail or manifold 70. From the manifold 70, the gas is distributed to one of more of the aforementioned fuel injectors 62. To complete the structure forming the system 29, as the engine 18 may be powered by either LNG or diesel fuel, the system 29 further includes the diesel fuel tank 28, diesel fuel pump 72, and diesel fuel rail or manifold 74 for distribution of diesel fuel to the fuel injectors 62. An electronic control module (ECM) 76 is provided to control operation of the LNG pump 30, the valve 68 and the diesel fuel pump 72.

As noted above, the LNG pump 30 may be called upon to deliver a variable volume of LNG depending upon the speed and/or load at which the engine 18 is operating. For example, if the machine 10 is engaged in digging, loading, or in otherwise using its work implement, the engine 18 will be operating at a rated speed, whereas if the machine 10 is not performing useful work and is simply idling, the engine 18 will be working at a lower idle speed. Of course at the higher rated speed, the engine 18 will be requiring more fuel than at the lower idle speed, the engine will be requiring less fuel. This, in turn, requires that the fuel pump 30 provide more or less fuel as dictated by the speed and/or the load of the engine 18. Other engine parameters can certainly be used to dictate the amount of fuel being supplied by the fuel pump 30. In order to supply the LNG, the pump 30 may be provided as a piston pump and may include one or more valve assemblies such as outlet check valve assemblies, which will be discussed in further detail herein.

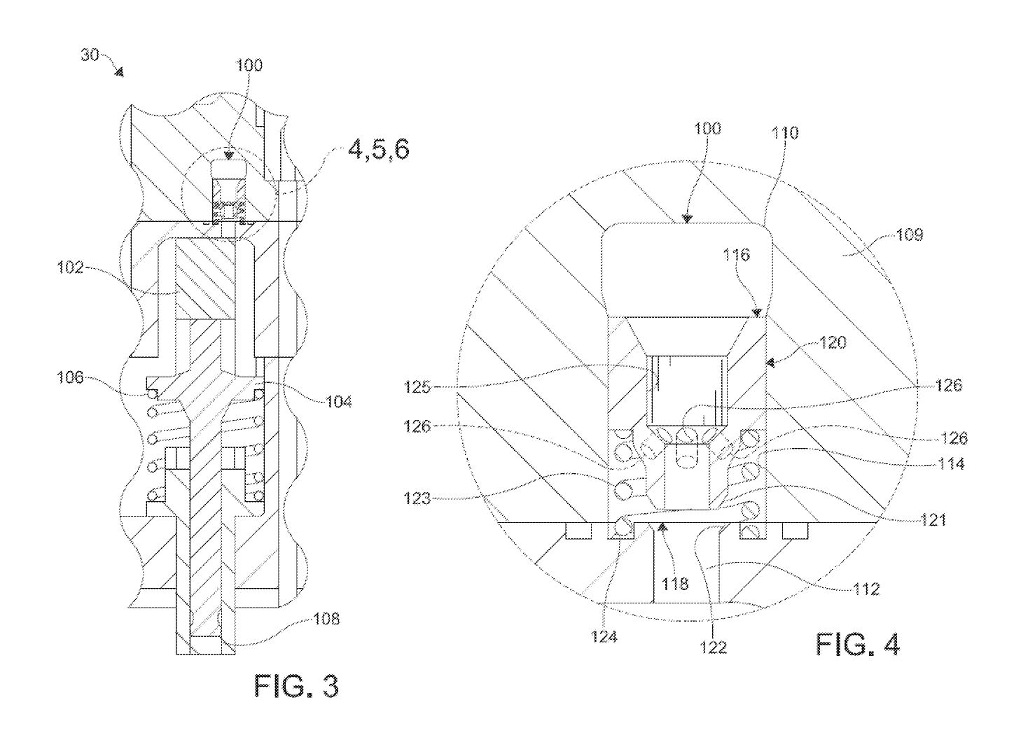

FIG. 3 illustrates a cross-sectional view of a portion of the fuel pump 30 including a valve assembly 100 in accordance with aspects of the disclosure. As shown, the valve assembly 100 can be configured to control a flow of fluid to a tappet 102. The tappet 102 can be configured to convert the hydraulic flow received from the valve assembly 100 to a linear mechanical force. In certain aspects, the tappet 102 can apply such a mechanical force to a pushrod 104, which may be biased against the applied force by a spring element 106. As the pushrod 104 is linearly displaced, a connecting rod 108 or plunger coupled to the pushrod 104 may also be displaced to operate at least a portion of the pump 30 to admit or discharge fuel.

As more clearly shown in FIG. 4, the valve assembly 100 may include a housing 109 defining a valve inlet 110 and a valve outlet 112. As shown, the valve assembly 100 may include a valve chamber 114 defined by a portion of the housing 109. The valve chamber 114 may have a first end 116 and a second end 118 opposite the first end 116. The valve chamber 114 may be in fluid communication with the valve inlet 110 and the valve outlet 112. As shown in FIG. 4, the valve inlet 110 may be disposed adjacent the first end 116 of the valve chamber 114 and the valve outlet 112 may be disposed adjacent the second end 118 of the valve chamber 114.

A valve body 120 may be moveably disposed in the valve chamber 114 and may slideably engage a portion of the housing 109. The valve body 120 may include a valve head 121 oriented toward the second end 118 of the valve chamber 114. The valve head 121 may be configured to sealingly abut a valve seat 122 formed in the housing 109, for example, adjacent the valve outlet 112 at the second end 118 of the valve chamber 114. It is understood that the valve seat 122 and the valve head 121 may have various shapes and sizes, for example. As shown in FIG. 4, the valve head 121 is spaced from the valve seat 122 such that the valve assembly 100 is in an opened position. As shown in FIG. 6, the valve head 121 is in sealing engagement with the valve seat 122 such that the valve assembly 100 is in a closed or seated position.

Returning to FIG. 4, a spring member 123 may be disposed in the valve chamber 114 and may be configured to bias the valve body 120 away from the valve seat 122. As shown, the spring member 123 is disposed between a portion of the housing 109 and the valve body 120. As an example, the spring member 123 may be or include a coil spring. Other biasing elements may be used. As a further example, a channel or recess 124 may be formed in the housing 109 to receive a portion of the spring member 123 and to retain a position of the spring member 123.

The valve body 120 may include a main fluid passage 125 and one or more control orifices 126 (e.g., auxiliary fluid passages) providing fluid communication between the valve inlet 110 and one or more of the valve chamber 114 and the valve outlet 112. The main fluid passage 125 may centrally disposed relative to the valve body 120 and may extend through the valve body 120 and may be configured to allow a fluid to pass therethrough at a predetermined flow rate. For example, a size and shape of the main fluid passage 125 may be configured to regulate a flow rate of fluid passing through the main fluid passage.

The control orifices 126 may be of varying size and shape. Further, the control orifices 126 may include one or multiple flow restriction means configured to controllably manipulate flow dynamics of the system. The control orifices 126 may include holes, channels (e.g., flutes), and other arrangements to control flow dynamics through or around the valve body 120.

As shown in FIG. 4, the control orifices 126 of the valve body 120 may provide fluid communication between the main fluid passage 125 and a portion of the valve chamber 114. The control orifices 126 may be configured to regulate a position of the valve body 120 between the first end 116 and the second end 118 of the valve chamber 114 based on a pressure difference between the valve inlet 110 and the valve outlet 112.

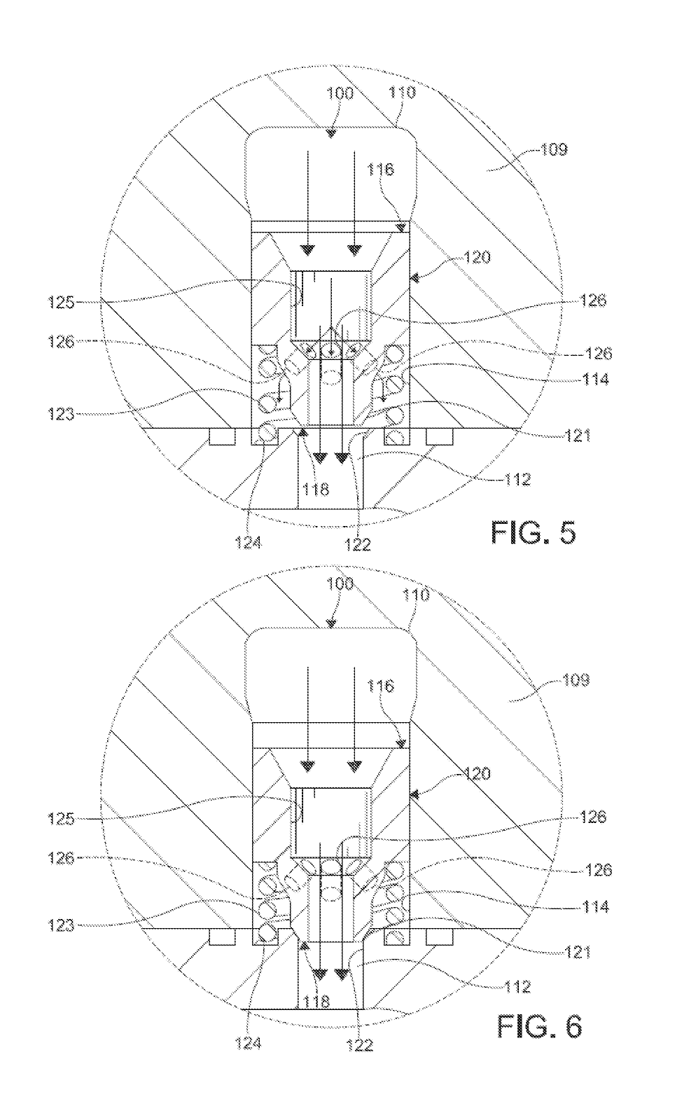

As shown in FIG. 5, the valve head 121 is spaced from the valve seat 122 such that the valve assembly 100 is in an opened position. As such, fluid may flow from the valve inlet 110 through the valve body 120 via both the main fluid passage 125 and the control orifices 126 and through the valve outlet 112. When pressure is reduced at the valve inlet 110 relative to the valve outlet 112, the spring member 123 biases the valve body 120 away from the valve seat 122 to maintain the valve assembly 100 in the opened position. As fluid pressure increase at the valve inlet 110, the valve body 120 may be forced toward the valve seat 122 in opposition to the bias of the spring member 123.

As shown in FIG. 6, fluid pressure at the valve inlet 110 may cause the valve body 120 to move toward the second end 118 of the valve chamber 114. As such, the valve head 121 may be caused to abut the valve seat 122 such that the valve assembly 100 is in a closed or seated position. While the valve head 121 is abutting the valve seat 122, a flow of fluid from the one or more control orifices 126 may be prevented from reaching the valve outlet 112. As such, the main fluid passage 125 provides sole control over fluid flowing between the valve inlet 110 and the valve outlet 112. As pressure at the valve inlet 110 is reduced relative to the valve outlet 112, the spring member 123 may bias the valve body 120 toward the first end 116 of the valve chamber 114 and the valve head 121 may separate from the valve seat 122, thereby allowing a flow of fluid from the one or more control orifices 126 to reach the valve outlet 112, for example, as illustrated in FIG. 5.

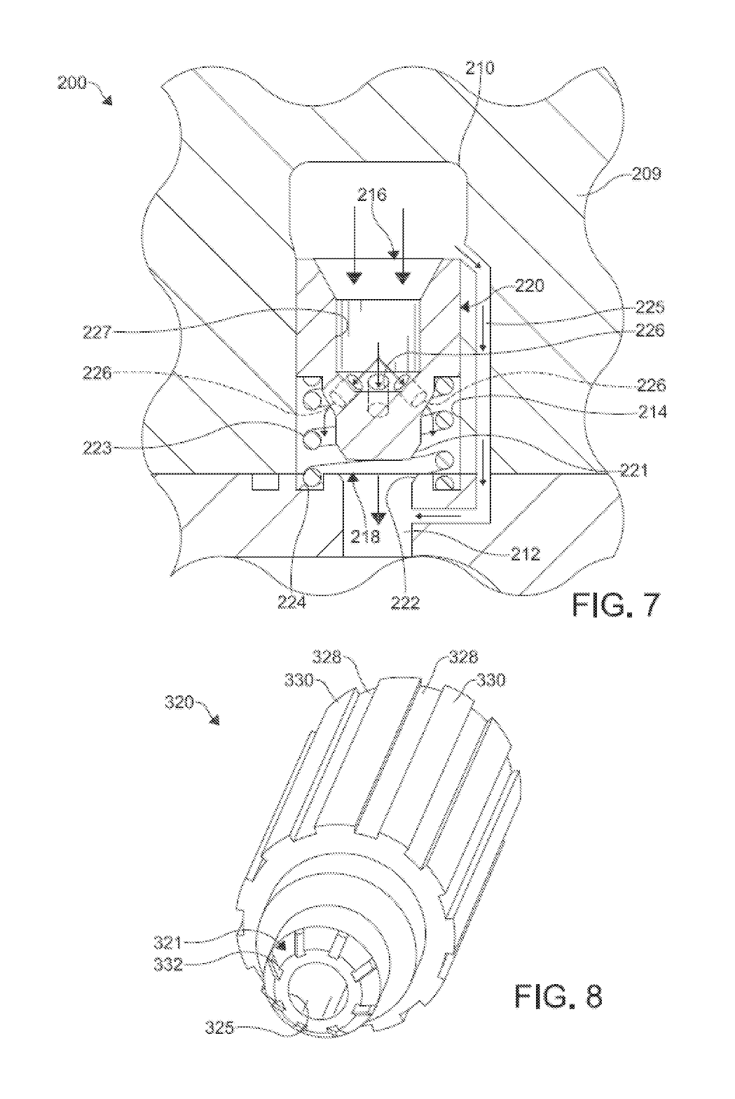

FIG. 7 illustrates a valve assembly 200 in accordance with aspects of this disclosure. The valve assembly 200 may include a housing 209 defining a valve inlet 210 and a valve outlet 212. As shown, the valve assembly 200 may include a valve chamber 214 defined by a portion of the housing 209. The valve chamber 214 may have a first end 216 and a second end 218 opposite the first end 216. The valve chamber 214 may be in fluid communication with the valve inlet 210 and the valve outlet 212. As shown in FIG. 7, the valve inlet 210 may be disposed adjacent the first end 216 of the valve chamber 214 and the valve outlet 212 may be disposed adjacent the second end 218 of the valve chamber 214.

A valve body 220 may be moveably disposed in the valve chamber 214 and may slideably engage a portion of the housing 209. The valve body 220 may include a valve head 221 oriented toward the second end 218 of the valve chamber 214. The valve head 221 may be configured to sealingly abut a valve seat 222 formed in the housing 209, for example, adjacent the valve outlet 212 at the second end 218 of the valve chamber 214. It is understood that the valve seat 222 and the valve head 221 may have various shapes and sizes, for example. As shown in FIG. 7, the valve head 221 is spaced from the valve seat 222 such that the valve assembly 200 is in an opened position.

A spring member 223 may be disposed in the valve chamber 214 and may be configured to bias the valve body 220 away from the valve seat 222. As shown, the spring member 223 is disposed between a portion of the housing 209 and the valve body 220. As an example, the spring member 223 may be or include a coil spring. Other biasing elements may be used. As a further example, a channel or recess 224 may be formed in the housing 209 to receive a portion of the spring member 223 and to retain a position of the spring member 223.

A main fluid passage 225 may be formed in the housing 209 and may be configured to allow a fluid to pass therethrough at a predetermined flow rate. For example, a size and shape of the main fluid passage 225 may be configured to regulate a flow rate of fluid passing through the main fluid passage 225. As an example, the main fluid passage 225 may bypasses a portion of the valve chamber 214 to provide fluid communication between the valve inlet 210 and the valve outlet 212 independent of a position of the valve body 220 in the valve chamber 214.

The valve body 220 may include a fluid chamber 227 and one or more control orifices 226 (e.g., auxiliary fluid passages) providing fluid communication between the valve inlet 210 and one or more of the valve chamber 214 and the valve outlet 212. The fluid chamber 227 may centrally disposed relative to the valve body and may extend into a portion of the valve body 220. The control orifices 226 may be of varying size and shape. Further, the control orifices 226 may include one or multiple flow restriction means configured to controllably manipulate flow dynamics of the system. The control orifices 226 may include holes, channels (e.g., flutes), and other arrangements to control flow dynamics through or around the valve body 220.

The control orifices 226 may provide fluid communication between the fluid chamber 227 and a portion of the valve chamber 214. The control orifices 226 may be configured to regulate a position of the valve body 220 between the first end 216 and the second end 218 of the valve chamber 214 based on a pressure difference between the valve inlet 210 and the valve outlet 212.

As shown in FIG. 7, the valve assembly 200 is in an opened position. As fluid pressure increases at the valve inlet 210 relative to the valve outlet 212, such pressure may cause the valve body 220 to move toward the second end 218 of the valve chamber 214. As such, the valve head 221 may be caused to abut the valve seat 222 such that the valve assembly 200 is in a closed or seated position. While the valve head 221 is abutting the valve seat 222, a flow of fluid from the one or more control orifices 226 may be prevented from reaching the valve outlet 212. As such, the main fluid passage 225 provides sole control over fluid flowing between the valve inlet 210 and the valve outlet 212. As an alternative, the valve head 221 may include fluid passages (not shown) such as channels, orifices, apertures, clearances, and the like to allow a finite amount of fluid to pass the valve head 221 when the valve head 221 is abutting the valve seat 222. This additional fluid control afforded by the fluid passages may be used in concert with the main fluid passage 225 to control an overall flow rate pass the valve body 220 when the valve body 220 is seated or closed. The fluid passages may be alternatively or additional formed in the valve seat 222. As pressure at the valve inlet 210 is reduced relative to the valve outlet 212, the spring member 223 may bias the valve body 220 toward the first end 216 of the valve chamber 214 and the valve head 221 may separate from the valve seat 222, thereby allowing a flow of fluid from the one or more control orifices 226 to reach the valve outlet 212, for example, as illustrated in FIG. 7.

FIG. 8 illustrates a valve body 320 similar to valve body 120 (FIG. 3) and valve body 220 (FIG. 7), except as described below. The valve body 320 may include a valve head 321 and may include a main fluid passage 325 extending therethrough and terminating adjacent the valve head 321. The main fluid passage 325 may be centrally disposed relative to the valve body 320 and may be configured to allow a fluid to pass therethrough at a predetermined flow rate. For example, a size and shape of the main fluid passage 325 may be configured to regulate a flow rate of fluid passing through the main fluid passage. One or more channels 328 (e.g., control orifices) and one or more protuberances 330 may be formed on an outer periphery of the valve body 320. The one or more protuberances 330 may be disposed adjacent the channels 328. As an example, the protuberances 330 may be sized to slideably engage a portion of a housing such as the housing 109 (FIG. 3), while the channels 328 allow a controlled flow of fluid to pass the valve body 320. Other configurations of the valve body 320 may be used to provide a controlled fluid dynamics around the valve body 320. In certain aspects, when the valve head 321 abuts a valve seat, fluid passing through the channels 328 may be prevented from passing the valve seat. In other aspects, the valve head 321 may include fluid passages 332 such as channels, orifices, apertures, clearances, and the like to allow a finite amount of fluid to pass the valve head 321 when the valve head 321 is seated. This additional fluid control afforded by the fluid passages 332 may be used in concert with the main fluid passage 325 to control an overall flow rate pass the valve body 320 when the valve body 320 is seated or closed. The fluid passages 332 may be alternatively or additional formed in a valve seat configured to abut or be disposed adjacent the valve head 321 when the valve body 320 is seated or closed. With or without the additional fluid passages 332, such fluid restriction may operate in a similar manner as the control orifices 126 (FIG. 3) to control fluid flow relative to the valve body 320.

### INDUSTRIAL APPLICABILITY

As noted above and with reference to FIGS. 1 and 2, the LNG pump 30 may be called upon to deliver a variable volume of LNG depending upon the opertion at which the engine 18 is operating. For example, if the machine 10 is engaged in digging, loading, or in otherwise using its work implement, the engine 18 will be operating at a rated speed, whereas if the machine 10 is not performing useful work and is simply idling, the engine 18 will be working at a lower idle speed. In order to supply the LNG, the pump 30 may be provided as a piston pump and may include one or more valve assemblies such as inlet valve for controlling an actuation of a tappet of the LNG pump 30.

Referring to FIGS. 3-8, the valve assemblies 100, 200 of this disclosure provide additional control of motion of a valve body 120, 220 by leveraging a main fluid passage 125, 225 and a control orifice 126, 226 or channel 328 that can be restricted based on increased pressure at a valve inlet 110, 210 relative to the valve outlet 112, 212. For example, in the context of a cryogenic pump, a tappet velocity for actuating a portion of the pump is desired to be constant at about 1.2 m/s. However, the valve that regulates the tappet motion may be sensitive to changes in pressure at the inlet of the valve. In accordance with aspects of the this disclosure the valve assembly 100, 200 may include a main fluid passage 125, 225, and in certain embodiments the fluid passages 332, to allow fluid to continue to pass through the valve assembly 100, 200 when the valve assembly 100, 200 is in a closed or seated position. This continued fluid flow facilitates the full extend stroke of the tappet under large supply pressures, where conventional valves would simply close off fluid flow and restrict tappet movement. Further, under supply pressures below a designed threshold (e.g., 24 MPa) the valve assembly 100, 200 may be opened or unseated and both the main fluid passage 125, 225 and the control orifices 126, 226 or channels 328 may be used to allow passage of fluid to the outlet 112, 212 of the valve assembly 100, 200 and thereby to the tappet. As such, maximized fluid flow may be allowed during lower pressures, but a restricted flow may be provided when supply pressure reaches a threshold. As such, the flow through the outlet 112, 212 of the valve assembly 100, 200 may be regulated and thereby an extend velocity of the tappet may be regulated to a constant velocity.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

We claim:

1. A valve assembly comprising:
a housing defining a valve chamber, wherein the valve chamber comprises a first end and a second end opposite the first end;
a valve inlet disposed adjacent the first end of the valve chamber and in fluid communication therewith, wherein the valve chamber is configured to receive a flow of fluid from the valve inlet;
a valve outlet in fluid communication with the valve chamber to receive a flow of fluid from the valve chamber;
a valve seat fixedly disposed at the first end of the valve chamber;
a valve body movably disposed within the valve chamber, the valve body comprising a valve head, a main fluid passage providing fluid communication between the valve inlet and the valve outlet, and one or more control orifices providing fluid communication between the main fluid passage and at least a portion of the valve chamber; and
a spring member disposed between the housing and the valve body, wherein the spring member is configured to bias the valve body away from the valve seat and towards the first end of the valve chamber, and wherein the valve head of the valve body is configured to abut against at least a portion of the valve seat to control a flow of fluid from the one or more control orifices to the valve outlet.

2. The valve assembly of claim 1, wherein the valve body further comprises at least one fluid channel formed therein.

3. The valve assembly of claim 2, wherein the at least one fluid channel is formed in an outer periphery of the valve body.

4. The valve assembly of claim 1, wherein the main fluid passage is central disposed in the valve body.

5. The valve assembly of claim 1, wherein the valve head of the valve body is configured to sealingly abut against the valve seat to prevent a flow of fluid from the one or more control orifices from reaching the valve outlet.

6. The valve assembly of claim 1, wherein the valve outlet is in fluid communication with a tappet of a cryogenic pump.

7. The valve assembly of claim 6, wherein a flow rate through the valve outlet is regulated to move the tappet at about 1.2 m/s or less.

8. A valve assembly comprising:
a housing defining a valve chamber and a main fluid passage, wherein the valve chamber comprises a first end and a second end opposite the first end;
a valve inlet disposed adjacent the first end of the valve chamber and in fluid communication therewith, wherein the valve chamber is configured to receive a flow of fluid from the valve inlet;
a valve outlet in fluid communication with the valve chamber to receive a flow of fluid from the valve chamber, wherein the main fluid passage provides fluid communication between the valve inlet and the valve outlet;
a valve seat fixedly disposed at the first end of the valve chamber;
a valve body movably disposed within the valve chamber, the valve body comprising a valve head, a fluid chamber, and one or more control orifices providing fluid communication between the fluid chamber and at least a portion of the valve chamber; and
a spring member disposed between the housing and the valve body, wherein the spring member is configured to bias the valve body away from the valve seat and towards the first end of the valve chamber, and wherein the valve head of the valve body is configured to abut against at least a portion of the valve seat to restrict a flow of fluid from the one or more control orifices toward the valve outlet.

9. The valve assembly of claim 8, wherein the valve body further comprises at least one fluid channel formed therein.

10. The valve assembly of claim 9, wherein the at least one fluid channel is formed in an outer periphery of the valve body.

11. The valve assembly of claim 8, wherein the main fluid passage bypasses a portion of the valve chamber to provide fluid communication between the valve inlet and the valve outlet independent of a position of the valve body in the valve chamber.

12. The valve assembly of claim 8, wherein the valve head of the valve body is configured to sealingly abut against the valve seat to prevent a flow of fluid from the one or more control orifices from reaching the valve outlet.

13. The valve assembly of claim 8, wherein the valve outlet is in fluid communication with a tappet of a cryogenic pump.

14. The valve assembly of claim 13, wherein a flow rate through the valve outlet is regulated to move the tappet at about 1.2 m/s or less.

15. A valve assembly comprising:
a housing defining a valve chamber, wherein the valve chamber comprises a first end and a second end opposite the first end;
a valve inlet disposed adjacent the first end of the valve chamber and in fluid communication therewith, wherein the valve chamber is configured to receive a flow of fluid from the valve inlet;
a valve outlet in fluid communication with the valve chamber to receive a flow of fluid from the valve chamber;
a valve seat fixedly disposed at the first end of the valve chamber;
a valve body movably disposed within the valve chamber, the valve body comprising a valve head, a main fluid passage providing fluid communication between the valve inlet and the valve outlet, and one or more channels formed on an outer periphery of the valve body to provide fluid communication between the valve inlet and at least a portion of the valve chamber; and
a spring member disposed between the housing and the valve body, wherein the spring member is configured to bias the valve body away from the valve seat and towards the first end of the valve chamber, and wherein the valve head of the valve body is configured to abut against at least a portion of the valve seat to control a flow of fluid from the one or more channels to the valve outlet.

16. The valve assembly of claim 15, wherein the valve body further comprises a protuberance disposed between two of the channels.

17. The valve assembly of claim 15, wherein the main fluid passage is central disposed in the valve body.

18. The valve assembly of claim 15, wherein the valve head of the valve body is configured to sealingly abut against the valve seat to prevent a flow of fluid from the one or more control orifices from reaching the valve outlet.

19. The valve assembly of claim 15, wherein the valve outlet is in fluid communication with a tappet of a cryogenic pump.

20. The valve assembly of claim 19, wherein a flow rate through the valve outlet is regulated to move the tappet at about 1.2 m/s or less.
